(19) United States
(12) Patent Application Publication
(10) Pub. No.: US 2025/0316243 A1
(43) Pub. Date: Oct. 9, 2025

(54) TIMING CONTROLLER AND METHOD OF DRIVING TIMING CONTROLLER

(71) Applicant: LX SEMICON CO., LTD., Daejeon (KR)

(72) Inventors: Pyeong Keun OH, Daejeon (KR); Sang Kwon KIM, Daejeon (KR)

(73) Assignee: LX SEMICON CO., LTD., Daejeon (KR)

(21) Appl. No.: 19/172,788

(22) Filed: Apr. 8, 2025

(30) Foreign Application Priority Data
Apr. 9, 2024 (KR) 10-2024-0048001

(51) Int. Cl. G09G 3/3291

(52) U.S. Cl. CPC G09G 3/3291; G09G 2310/08; G09G 2370/04

(57) ABSTRACT

A method of driving a timing controller includes requesting, by a processor, first line data from a controller; extracting, by the controller, the first line data from a storage memory and loading the extracted first line data into a shared memory; transferring, by the controller, the first line data loaded into the shared memory to the processor; and reading, by the controller, update data for updating an operation of the storage memory from the storage memory in response to the transfer of the first line data.

### CROSS-REFERENCE TO RELATED APPLICATION

This application claims the priority of Korean Patent Application No. 10-2024-0048001, filed on Apr. 9, 2024, which is hereby incorporated by reference in its entirety.

### BACKGROUND

### Field of the Disclosure

The present disclosure relates to a timing controller and a method of driving a timing controller.

### Description of the Background

In the information age, the field of display technology, which visually represents electrical information signals, has rapidly advanced, leading to the development of various display devices with excellent performance.

A display device includes a display panel, panel drivers that drive the display panel, which include a source driver for generating a driving voltage to drive a plurality of data lines and a gate driver for generating a driving voltage to drive a plurality of gate lines, and a timing controller that controls the panel driver.

The timing controller is increasingly being applied beyond display devices to systems in a wide range of product groups, and accordingly, satisfying the booting time required by the corresponding system has emerged as a key factor for the timing controller.

### SUMMARY

The present disclosure is directed to providing a technology for preventing a storage memory from entering a mode for reducing energy consumption while a processor is processing line data.

The present disclosure is not limited to the above, and other features that are not described above will be clearly understood by those skilled in the art from the above detailed description.

There is provided a method of driving a timing controller, which includes: requesting, by a processor, first line data from a controller; extracting, by the controller, the first line data from a storage memory and loading the extracted first line data into a shared memory; transferring, by the controller, the first line data loaded into the shared memory to the processor; and reading, by the controller, update data for updating an operation of the storage memory from the storage memory in response to the transfer of the first line data.

The method may further include loading the update data read by the controller into the shared memory.

The loading may include loading the update data read by the controller into a reserved area of the shared memory.

The reserved area may be a different area from an area in which the line data may be loaded among storage areas of the shared memory.

The shared memory may be included in the controller, and the storage memory may store a plurality of pieces of region data including a plurality of pieces of line data.

The method may further include: receiving, by the controller, a first request signal requesting the loading of the first line data, and a first address signal for the first line data to be loaded from the processor; and extracting, by the controller, the first line data corresponding to the first address signal from the storage memory in response to the first request signal, and loading, by the controller, the extracted first line data into the shared memory; and transmitting, by the controller, a first completion signal to the processor upon completing the loading of the extracted first line data.

The method may include: receiving, by the controller, a second request signal requesting loading of second line data and a second address signal for the second line data to be loaded from the processor; holding, by the controller, the second request signal and the second address signal when the controller has not loaded all the update data into the shared memory; upon loading all the update data into the shared memory, extracting, by the controller, the second line data corresponding to the second address signal from the storage memory in response to the second request signal; loading, by the controller, the extracted second line data into the shared memory; and upon completing the loading of the extracted second line data, transmitting, by the controller, a second completion signal to the processor.

There is provided a timing controller including: a storage memory that stores a plurality of pieces of region data including a plurality of pieces of line data; a processor that requests loading of the plurality of pieces of line data included in the region data using a request signal and an address signal, receives and processes the loaded line data, and transmits the processed line data; and a controller that includes a shared memory, in which the line data is loaded and transmitted, and loads line data extracted from the storage memory into the shared memory in response to the request signal, wherein the controller is configured to: transfer the line data loaded into the shared memory to the processor; and read update data for updating an operation of the storage memory from the storage memory in response to the transfer of the line data.

The controller may read update data from the storage memory and load the read update data into the shared memory while the processor is processing the line data.

The controller may, when a request for next line data is received from the processor while loading the update data into the shared memory, hold the request for the next line data during a time taken to load all the update data into the shared memory.

### BRIEF DESCRIPTION OF THE DRAWINGS

The above and other features and advantages of the present disclosure will become more apparent to those of ordinary skill in the art by describing exemplary aspects thereof in detail with reference to the accompanying drawings, in which:

FIG. 1 is a schematic block diagram illustrating a display device according to an aspect;

FIG. 2 is a block diagram illustrating a timing controller according to an aspect;

FIG. 3 is a block diagram illustrating a configuration of the timing controller shown in FIG. 2;

FIG. 4 is a diagram illustrating an example of a region data structure;

FIG. 5 is a diagram illustrating an example of a request signal structure;

FIG. 6 is a diagram illustrating an example of an address signal structure;

FIG. 7 is a sequence diagram illustrating an example of the operation of a timing controller;

FIG. 8 is a diagram illustrating an example of signals, data, and processing operations transmitted and received by a timing controller over time;

FIG. 9 is a sequence diagram illustrating another example of the operation of a timing controller;

FIG. 10 is a diagram illustrating another example of signals, data, and processing operations transmitted and received by a timing controller over time; and

FIG. 11 is a diagram illustrating performance improvement results when using a timing controller according to an aspect.

### DETAILED DESCRIPTION

Hereinafter, aspects of the present specification will be described in detail with reference to the accompanying drawings. In the drawings, identical or similar parts will be assigned the same number throughout the drawings, and redundant descriptions thereof will be omitted. The terms “module,” “part,” and “unit” used for elements in the following description have only been assigned or used together in consideration of the ease of writing the specification and do not have distinct meanings or roles by themselves. In the description of the aspects, detailed descriptions of related known techniques will be omitted to avoid obscuring the subject matter of the present disclosure. In addition, the accompanying drawings are used to aid in the understanding of the aspects of the present specification, and the technical spirit of the present specification is not limited by the accompanying drawings and encompasses all modifications, equivalents, and alternatives falling within the spirit and scope of the present specification.

It should be understood that, although terms including ordinal numbers, such as first, second, etc., may be used herein to describe various elements, these elements are not limited by these terms. These terms are only used to distinguish one element from another element.

It should be understood that, when an element is referred to as being “connected to” or “coupled to” another element, the element may be directly connected or coupled to another element, or intervening elements may be present. Conversely, when an element is referred to as being “directly connected to” or “directly coupled to” another element, there are no intervening elements present.

As used herein, the singular forms “a,” “an,” and “one” are intended to include the plural forms as well, unless the context clearly indicates otherwise.

It should be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

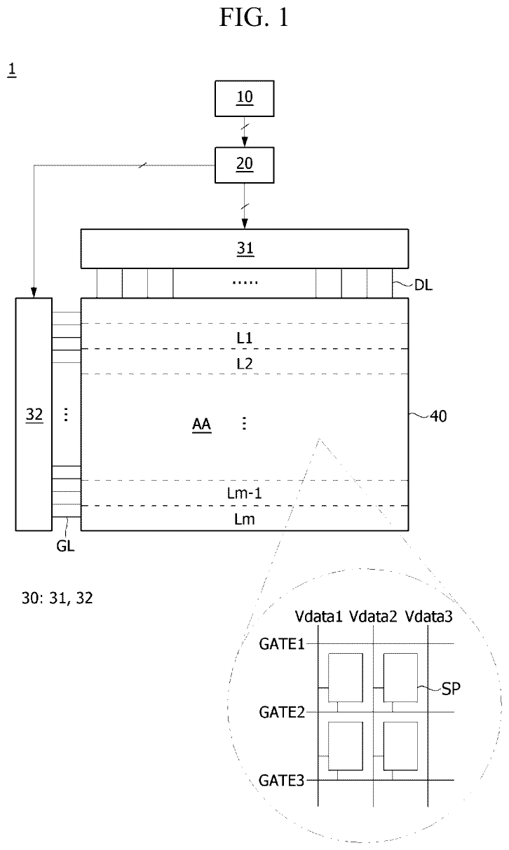

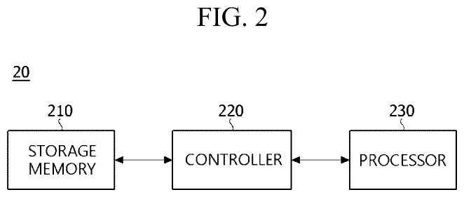

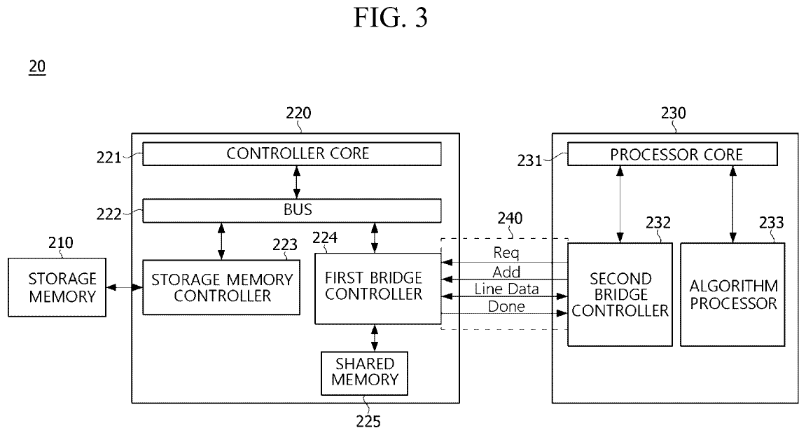

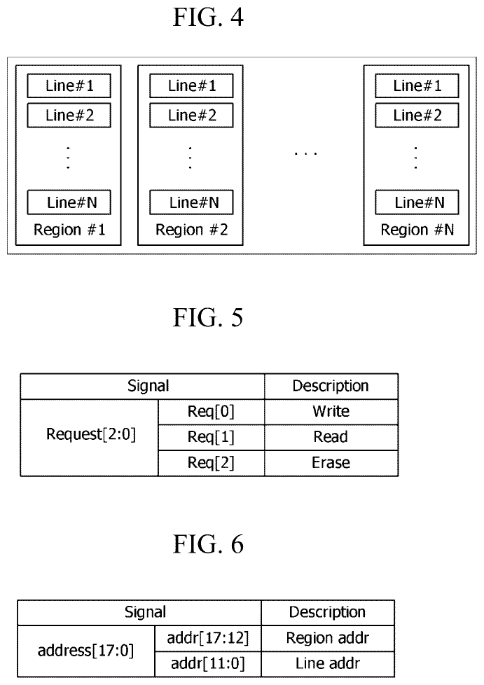

FIG. 1 is a schematic block diagram illustrating a display device according to an aspect, FIG. 2 is a block diagram illustrating a timing controller according to an aspect, FIG. 3 is a block diagram illustrating a configuration of the timing controller shown in FIG. 2, FIG. 4 is a diagram illustrating an example of an region data structure, FIG. 5 is a diagram illustrating an example of a request signal structure, and FIG. 6 is a diagram illustrating an example of an address signal structure.

A display device 1 includes a host system 10, a timing controller 20, a panel driver 30, and a display panel 40.

The host system 10 may be any one of a television (TV), a set-top box, a navigation system, a personal computer (PC), a home theater, a mobile system, and a wearable system. In mobile devices and wearable devices, the panel driver 30, the timing controller 20, and the like may be integrated into a single drive integrated chip (IC) (not shown).

For example, in a mobile system, the host system 10 may be implemented as an application processor (AP). The host system 10 may transmit pixel data of an input image to the drive IC through a mobile industry processor interface (MIPI). The host system 10 may be connected to the drive IC through a flexible printed circuit, for example, a flexible printed circuit (FPC).

The timing controller 20 may receive pixel data of an input image and a driving signal synchronized with the pixel data from the host system 10. The timing controller 20 may control the panel driver 30.

The pixel data of the input image received by the timing controller 20 is a digital signal. The timing controller 20 transmits the pixel data to a source driver 31. A timing signal may include a vertical synchronization signal Vsync, a horizontal synchronization signal Hsync, a clock signal (DCLK), and a data enable signal DE. Since the vertical period and the horizontal period are identifiable by counting the data enable signal DE, the vertical synchronization signal Vsync and the horizontal synchronization signal Hsync may be omitted. The data enable signal DE has a cycle of 1 horizontal period 1H.

The timing controller 20 may generate a data timing control signal for controlling the source driver 31 and a gate timing control signal for controlling a gate driver 32 based on the timing signal received from the host system 10, thereby controlling the operation timing of the source driver 31 and the gate driver 32.

The voltage level of the gate timing control signal output from the timing controller 20 may be converted into a gate-on voltage VGL and a gate-off voltage VGH through a level shifter (not shown) and supplied to the gate driver 32. The level shifter converts a low level voltage of the gate timing control signal into a gate low voltage VGL and converts a high level voltage of the gate timing control signal into a gate high voltage VGH.

The timing controller 20 may, during a data sharing process between a controller 220 and a processor 230 included in the timing controller 20, prevent a storage memory 210 storing data to be transmitted to the processor 230 from entering a mode for reducing energy consumption due to not receiving a signal for a certain period of time, thereby preventing performance degradation, such as a delay in booting time of the display device 1 or the system including the timing controller 20, and thus shortening the booting time. That is, the timing controller 20 may be applied not only to the display device 1, but also to other systems (not shown).

The timing controller 20 may prevent the storage memory 210 from entering a mode for reducing energy consumption by reading update data for updating the operation of the storage memory 210 from the storage memory 210 while the processor 230 processes line data, and may prevent performance degradation, such as a delay in the booting time of the system, thereby shortening the booting time of the system.

The timing controller 20 may include the storage memory 210, the controller 220, and the processor 230. The timing controller 20 may further include a bridge interface 240.

The storage memory 210 may store a plurality of pieces of region data including a plurality of pieces of line data.

For example, FIG. 4 is an exemplary block diagram illustrating a structure of region data, and a plurality of pieces of region data Region #1 to Region #N may each include a plurality of pieces of line data Line #1 to Line #N. The region data may be data used in an OLED compensation algorithm.

For example, the storage memory 210 may be implemented as an embedded multi-media card (eMMC).

The controller 220 may receive, from the processor 230, a first request signal requesting loading of first line data and a first address signal for the first line data to be loaded.

For example, FIG. 5 is an exemplary a block diagram illustrating a structure of a request signal transmitted by the processor 230, and the request signal may be composed of 3 bits, and the bits may be formed as bits for Write, Read, and Erase.

For example, FIG. 6 is an exemplary block diagram illustrating a structure of an address signal transmitted by the processor 230, and the address signal may be composed of 18 bits, and the bits may be formed as bits for a region address for region data and a line address for line data.

The controller 220 may, in response to the first request signal, extract first line data corresponding to the first address signal from the storage memory 210.

The controller 220 may load the extracted first line data into a shared memory 225.

The controller 220 may, upon completing loading of the extracted first line data, transmit a first completion signal to the processor 230.

The controller 220 may, upon transmitting the first completion signal, transfer the first line data loaded in the shared memory 225 to the processor 230.

The controller 220 may, in response to the transfer of the first line data, read update data for updating the operation of the storage memory 210 from the storage memory 210.

For example, the update data may have the same size as one sector of the storage memory 210. As an example, the update data may have a size of 512 bytes, which is a size of one sector of the storage memory 210.

The controller 220 may load the read update data into the shared memory 225.

For example, the controller 220 may load the read update data into a reserved area of the shared memory 225. For example, the reserved area may be a different area from an area in which line data is loaded among storage areas of the shared memory 225. For example, the storage areas of the shared memory 225 may include a reserved area, a committed area, and a free area. Line data may be loaded into the committed area. The free area may be a memory area that has not yet been allocated.

When the controller 220 does not read update data from the storage memory 210 during a line data processing time of the processor 230, the storage memory 210 may enter a mode for energy reduction depending on the line data processing time of the processor 230. That is, when the line data processing time of the processor 230 is longer than a time for entering a mode for energy reduction of the storage memory 210, the controller 220 may not receive a request signal and an address signal from the processor 230, and thus the storage memory 210 may enter the mode for energy reduction.

Once the storage memory 210 enters the mode for energy reduction, when the controller 220 reads line data from the storage memory 210 in response to a request signal and an address signal received from the processor 230, a wakeup time of the storage memory 210 may be added, which may cause a decrease in booting performance. The wakeup time may be the time taken for the storage memory 210 to return from a mode for energy reduction to a normal operation mode.

Accordingly, while the processor 230 processes line data, the controller 220 reads update data from the storage memory 210 to prevent the storage memory 210 from entering a mode for energy reduction, and prevent performance degradation, such as a delay in the system's booting time, thereby shortening the system's booting time.

The controller 220 may receive, from the processor 230, a second request signal requesting loading of second line data and a second address signal for the second line data to be loaded.

The controller 220 may, upon loading all the update data into the shared memory 225, extract the second line data corresponding to the second address signal from the storage memory 210 in response to the second request signal.

For example, the controller 220 may, upon not loading all the update data into the shared memory 225, hold the second request signal and the second address signal until all the update data is loaded into the shared memory 225.

Specifically, when the controller 220 receives a request signal and an address signal after reading update data from the storage memory 210 and completing loading of the update data into the reserved area of the shared memory 225, the controller 220 may extract line data according to the received request signal and the received address signal and load the extracted line data into the shared memory 225. However, when the controller 220 receives a request signal and an address signal while reading update data from the storage memory 210 and loading the update data into the reserved area of the shared memory 225, the controller 220 may hold the request signal and the address signal, and after completing the loading of the update data, extract line data according to the received request signal and the received address signal and load the extracted line data into the shared memory 225.

The controller 220 may load the extracted second line data into the shared memory 225.

The controller 220 may, upon completing loading of the extracted second line data, transmit a second completion signal to the processor 230.

The controller 220 may receive, from the processor 230, an n^{th} request signal requesting loading of n^{th} line data and an n^{th} address signal for the n^{th} line data to be loaded, and may repeat the above-described operation in response to the n^{th} request signal and the n^{th} address signal.

The controller 220 may be implemented as a micro controller unit (MCU).

The controller 220 may include a controller core 221, a bus 222, a storage memory controller 223, a first bridge controller 224, and a shared memory 225.

The controller core 221 may perform the internal operations of the controller 220 and control peripheral components (not shown) within the timing controller 20.

The bus 222 may connect the controller core 221, the storage memory controller 223, and the first bridge controller 224, allowing transfer of data and signals.

The storage memory controller 223 may control the storage memory 210, extract data stored in the storage memory 210, and store data in the storage memory 210.

The first bridge controller 224 may perform an operation according to a signal received from the processor 230.

The first bridge controller 224 may load line data extracted from the storage memory 210 through the storage memory controller 223 into the shared memory 225.

The first bridge controller 224 may transmit a completion signal to the processor 230 after loading the extracted line data.

The first bridge controller 224 may transmit the line data loaded into the shared memory 225 to the processor 230.

The first bridge controller 224 may store the processed line data received from the processor 230 in the shared memory 225.

The shared memory 225 may load and/or transmit line data extracted from the storage memory 210.

The shared memory 225 may load and/or transmit line data processed by the processor 230.

The processor 230 may transmit, to the controller 220, a first request signal requesting loading of first line data and a first address signal for the first line data to be loaded.

The processor 230 may receive the first line data from the shared memory 225 of the controller 220 in response to a first completion signal notifying that the controller 220 has loaded the first line data corresponding to the first address signal into the shared memory 225.

The processor 230 may process the received first line data and transmit the processed first line data to the controller 220.

The processor 230 may transmit, to the controller 220, a second request signal requesting loading of second line data and a second address signal for the second line data to be loaded.

The processor 230 may receive the second line data from the shared memory 225 of the controller 220 in response to a second completion signal notifying that the controller 220 has loaded the second line data corresponding to the second address signal into the shared memory 225.

The processor 230 may process the received second line data and transmit the processed second line data to the controller 220.

The processor 230 may transmit, to the controller 220, an n^{th} request signal requesting loading of n^{th} line data and an n-th address signal for the n^{th} line data to be loaded, and may repeatedly perform the above-described operations in response to an n-th completion signal.

The processor 230 may be implemented as a micro-processor unit (MPU).

The processor 230 may include a processor core 231, a second bridge controller 232, and an algorithm processor 233.

The processor core 231 may control the second bridge controller 232 and the algorithm processor 233.

The second bridge controller 232 may control the bridge interface 240 according to a request signal transmitted from the processor core 231.

The algorithm processor 233 may process line data and transmit the processed line data. For example, the algorithm processor 233 may process an algorithm regarding compensation data of an OLED panel.

The bridge interface 240 may transmit signals and data between the controller 220 and the processor 230.

The panel driver 30 may drive the display panel 40.

The panel driver 30 may include a source driver 31 and a gate driver 32.

The source driver 31 may, in response to image data and a horizontal synchronization signal Hsync output from the timing controller 20, output output signals corresponding to the image data to the display panel 40 through data lines DL.

The source driver 31 converts pixel data of an input image received as a digital signal from the timing controller 20 for each frame into an analog gamma compensation voltage using a digital-to-analog converter (DAC) and outputs data signals Vdata1 to Vdata3. The data signals Vdata1 to Vdata3 may be supplied to the data lines DL.

The gate driver 32 receives a gate timing control signal and outputs gate signals GATE1 to GATE3 synchronized with the data signals Vdata1 to Vdata3 and supplies the gate signals GATE1 to GATE3 to pixel lines GL. The gate signals GATE1 to GATE3 applied to the pixel lines GL turn on switch elements of sub-pixels SP to select a pixel line on which the voltage of the data signals Vdata1 to Vdata3 is charged.

The display panel 40 may display an image.

The display panel 40 may include a pixel array AA that displays pixel data of an input image on a screen.

The pixel array AA includes a plurality of data lines DL, a plurality of pixel lines GL intersecting the data lines DL, and pixels arranged in a matrix form. In addition to the matrix form, the arrangement of the pixels may be formed in various forms, such as a form in which pixels emitting the same color are shared, a stripe form, a diamond form, and the like

When the resolution of the pixel array AA is n*m, the pixel array AA includes n pixel columns and m pixel lines L1 to Lm intersecting the pixel columns. The pixel columns include pixels arranged along the y-axis direction. The pixel lines include pixels arranged along the x-axis direction.

One horizontal period 1H is the time obtained by dividing one frame period by the number of m pixel lines L1 to Lm. During one horizontal period 1H, pixel data may be written to pixels of one pixel line. For example, one pixel line may be a line into which data voltages are simultaneously input during one horizontal period 1H.

Each of the pixels may be divided into a red sub-pixel, a green sub-pixel, and a blue sub-pixel for color implementation. Each of the pixels may further include a white sub-pixel.

Each of the sub-pixels SP includes a pixel circuit. The pixel circuit includes a pixel electrode, a plurality of thin film transistors (TFTs), and a capacitor. The pixel circuit may be connected to a data line DL and a pixel line GL.

The pixel circuit may include a light-emitting element, a plurality of transistors, and a capacitor. The light-emitting element may be implemented as an organic light-emitting diode (OLED). Each of the sub-pixels is connected to a pair of data lines, a feedback line, and a gate line. The gate lines may be divided into a scan line to which a scan signal is applied, and an EM line to which an emission control signal is applied.

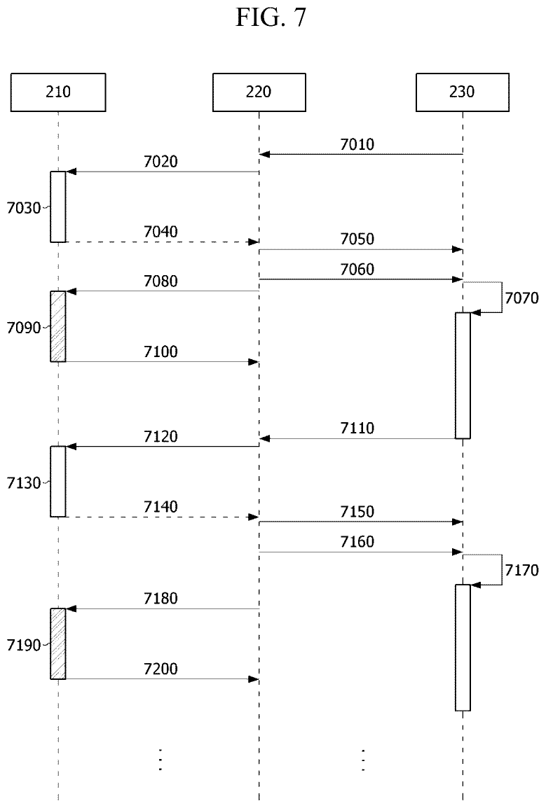

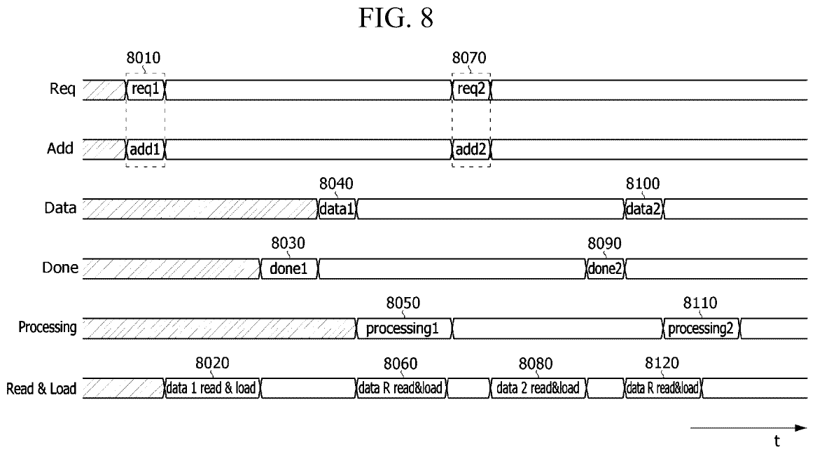

FIG. 7 is a sequence diagram illustrating an example of the operation of a timing controller, and FIG. 8 is a diagram illustrating an example of signals, data, and processing operations transmitted and received by a timing controller over time.

The processor 230 may transmit, to the controller 220, a first request signal req1 requesting loading of first line data data1, and a first address signal add1 for the first line data data1 to be loaded (7010 and 8010).

The controller 220 may receive, from the processor 230, the first request signal req1 requesting loading of the first line data data1 and the first address signal add1 for the first line data data1 to be loaded.

For example, the controller 220 may, in response to the first request signal req1, extract the first line data data1 corresponding to the first address signal add1 from the storage memory 210 (7020).

The controller 220 may load the extracted first line data data1 into the shared memory 225 (7030 and 8020).

The storage memory 210 may transmit a first extraction completion signal to the controller 220 when all the first line data data1 is extracted (7040).

The controller 220 may, upon completing loading of the extracted first line data data1, transmit a first completion signal done1 to the processor 230 (7050 and 8030).

The controller 220 may, upon transmitting the first completion signal done1, transfer the first line data data1 loaded in the shared memory 225 to the processor 230. The processor 230 may receive the first line data data1 from the shared memory 225 of the controller 220 in response to the first completion signal done1 notifying that the controller 220 has loaded the first line data data1 corresponding to the first address signal add1 into the shared memory 225 (7060 and 8040).

The processor 230 may process the received first line data data1 and transmit the processed first line data to the controller 220 (7070 and 8050).

The controller 220 may, in response to the transfer of the first line data data1, read update data dataR for updating the operation of the storage memory 210 from the storage memory 210 (7080 and 8060).

The controller 220 may load the read update data dataR into the shared memory 225 (7090 and 8060).

The storage memory 210 may, upon all the update data dataR being extracted, transmit an extraction completion signal to the controller 220 (7100).

The processor 230 may transmit, to the controller 220, a second request signal req2 requesting loading of second line data and a second address signal add2 for the second line data to be loaded (7110 and 8070).

The controller 220 may receive, from the processor 230, the second request signal req2 requesting the loading of the second line data and the second address signal add2 for the second line data to be loaded.

The controller 220 may, upon loading all the update data dataR into the shared memory 225, extract the second line data data2 corresponding to the second address signal add2 from the storage memory 210 in response to the second request signal req2 (7120 and 8080).

The controller 220 may load the extracted second line data data2 into the shared memory 225 (7130 and 8080).

The storage memory 210 may, when all the second line data data2 is extracted, transmit a second extraction completion signal to the controller 220 (7140).

The controller 220 may, upon completing loading of the extracted second line data data2, transmit a second completion signal done2 to the processor 230 (7150 and 8090).

The controller 220 may transfer the second line data data2 loaded into the shared memory 225 to the processor 230. The processor 230 may, in response to the second completion signal done2 notifying that the controller 220 has loaded the second line data data2 corresponding to the second address signal add2 into the shared memory 225, receive the second line data data2 from the shared memory 225 of the controller 220 (7160 and 8100).

The processor 230 may process the received second line data data2 and transmit the processed second line data to the controller 220 (7170 and 8110).

The controller 220 may, in response to the transfer of the second line data data2, read update data dataR for updating the operation of the storage memory 210 from the storage memory 210 (7180 and 8120).

The controller 220 may load the read update data dataR into the shared memory 225 (7190).

The storage memory 210 may transmit an extraction completion signal to the controller 220 when all the update data dataR are extracted (7200).

The storage memory 210, the controller 220, and the processor 230 may repeat the above-described operations according to an n^{th} request signal and an n^{th} address signal.

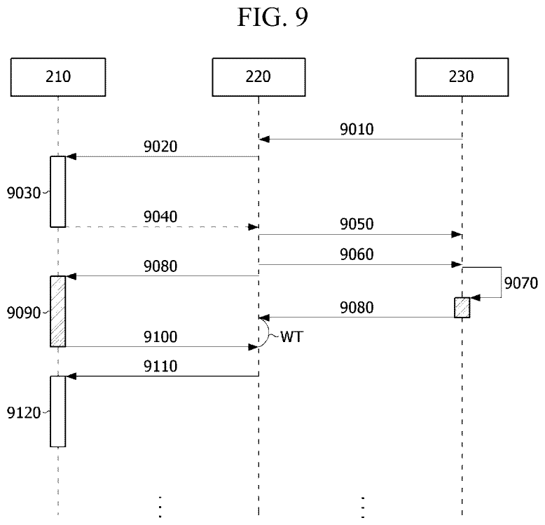

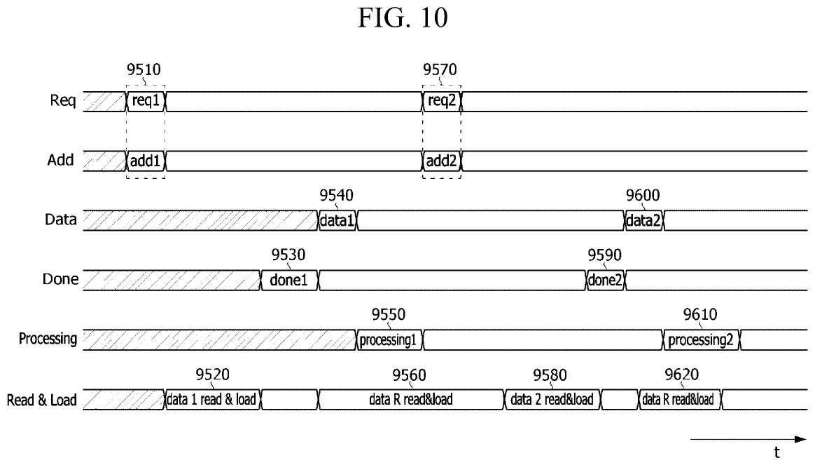

FIG. 9 is a sequence diagram illustrating another example of the operation of a timing controller, and FIG. 10 is a diagram illustrating another example of signals, data, and processing operations transmitted and received by a timing controller over time.

The processor 230 may transmit, to the controller 220, a first request signal req1 requesting loading of first line data data1, and a first address signal add1 for the first line data data1 to be loaded (9010).

The controller 220 may receive, from the processor 230, the first request signal req1 requesting loading of the first line data data1 and the first address signal add1 for the first line data data1 to be loaded.

The controller 220 may, in response to the first request signal req1, extract the first line data data1 corresponding to the first address signal add1 from the storage memory 210 (9020).

The controller 220 may load the extracted first line data data1 into the shared memory 225 (9030).

The storage memory 210 may transmit a line data extraction completion signal to the controller 220 when all the first line data data1 is extracted (9040).

The controller 220 may, upon completing loading of the extracted first line data data1, transmit a first completion signal done1 to the processor 230 (9050).

The controller 220 may transfer the first line data data1 loaded in the shared memory 225 to the processor 230. The processor 230 may receive the first line data data1 from the shared memory 225 of the controller 220 in response to the first completion signal done1 notifying that the controller 220 has loaded the first line data data1 corresponding to the first address signal add1 into the shared memory 225 (9060).

The processor 230 may process the received first line data data1 and transmit the processed first line data to the controller 220 (9070).

The processor 230 may transmit, to the controller 220, a second request signal req2 requesting loading of second line data data2 and a second address signal add2 for the second line data data2 to be loaded (9080).

The controller 220 may, in response to the transfer of the first line data data1, read update data dataR for updating the operation of the storage memory 210 from the storage memory 210. The controller 220 may load the read update data dataR into the shared memory 225 (9090).

The controller 220 may, when the second request signal and the second address signal are received during loading of the read update data dataR into the shared memory 225 (9080), hold the second request signal req2 and the second address signal add2 for a duration WT until all the update data is loaded into the shared memory 225.

The storage memory 210 may transmit an extraction completion signal to the controller 220 when all the update data dataR is extracted (9100).

The controller 220 may, upon loading all the update data dataR into the shared memory 225, extract the second line data data2 corresponding to the second address signal add2 from the storage memory 210 in response to the second request signal req2 (9110).

The controller 220 may load the extracted second line data data2 into the shared memory 225 (9120).

The operations described above through FIGS. 9 and 10 describe operations of the controller 220 when the controller 220 receives a request signal and an address signal in the middle of reading update data from the storage memory 210 and loading the update data into the shared memory 225.

Operations after operation 9120 may vary depending on the timing of reception of a request signal and an address signal received by the controller 220.

That is, when the controller 220 has loaded all the update data into the shared memory 225, the controller 220 may operate in a method as described through FIGS. 7 and 8, and when the controller 220 has not loaded all the update data into the shared memory 225, the controller 220 may hold the request signal and the address signal for a duration WT until all the update data is loaded into the shared memory 225 as described through FIGS. 9 and 10.

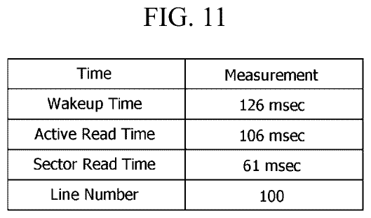

FIG. 11 is a diagram illustrating performance improvement results when using a timing controller according to an aspect.

In FIG. 11, a wakeup time, a line data read time Active Read Time, an update data read time Sector Read Time, and a line number Line Number according to an example of loading line data having an 8k-byte line size are illustrated.

When the storage memory 210 does not receive a signal for a certain period of time and enters a mode for reducing energy consumption, the wakeup time until normal operation resumes may be 126 msec.

As an operation of the timing controller 220 according to an aspect, the timing controller 220 reads update data from the storage memory 210 during the line data processing time of the processor 230, and it may be seen that the wakeup time Wakeup Time is more than twice as long as the time for reading the update data Sector Read Time.

That is, by preventing the storage memory 210 from entering a mode for reducing energy consumption through an operation of the timing controller 220, the wakeup time of the storage memory 210 may be eliminated, thereby shortening the booting time of the system.

The present disclosure may prevent a storage memory from entering a mode for reducing energy consumption by reading update data from the storage memory while a processor is processing line data, thereby preventing performance degradation, such as booting time delays of a system, and thus shortening the booting time of the system.

The effects of the present disclosure are not limited to those described above, and other effects that are not described above will be clearly understood by those skilled in the art from the above detailed description.

Although aspects of the present disclosure have been described in more detail with reference to the accompanying drawings, the present disclosure is not necessarily limited to these aspects, and various modifications may be made within the scope of the technical spirit of the present disclosure. Therefore, the aspects disclosed herein are not intended to limit the technical spirit of the present disclosure, but to explain the technical spirit, and the scope of the technical spirit of the present disclosure is not limited by these aspects. Therefore, it should be understood that the aspects described above are illustrative in all respects and not restrictive. The protection scope of the present disclosure should be interpreted according to the scope of the claims, and all technical ideas within the equivalent scope should be construed as being included in the scope of the present disclosure.

What is claimed is:

1. A method of driving a timing controller, comprising:
requesting, by a processor, first line data from a controller;
extracting, by the controller, the first line data from a storage memory and loading the extracted first line data into a shared memory;
transferring, by the controller, the first line data loaded into the shared memory to the processor; and
reading, by the controller, update data for updating an operation of the storage memory from the storage memory in response to the transfer of the first line data.

2. The method of claim 1, further comprising loading the update data read by the controller into the shared memory.

3. The method of claim 2, wherein the loading includes loading the update data read by the controller into a reserved area of the shared memory.

4. The method of claim 3, wherein the reserved area is a different area from an area in which the line data is loaded among storage areas of the shared memory.

5. The method of claim 1, wherein the shared memory is included in the controller, and
the storage memory stores a plurality of pieces of region data including a plurality of pieces of line data.

6. The method of claim 2, where the requesting includes:
transmitting, by the processor, a first request signal requesting the loading of the first line data, and a first address signal for the first line data to be loaded to the controller; and
receiving, by the controller, the first request signal and the first address signal.

7. The method of claim 6, wherein the loading includes:
extracting, by the controller, the first line data corresponding to the first address signal from the storage memory in response to the first request signal;
loading, by the controller, the extracted first line data into the shared memory; and
transmitting, by the controller, a first completion signal to the processor upon completing the loading of the extracted first line data.

8. The method of claim 7, wherein the reading includes reading, by the controller, the update data from the storage memory, and loading the read update data into the shared memory.

9. The method of claim 8, further comprising:
after loading all the update data into the shared memory, receiving, by the controller, a second request signal requesting loading of second line data and a second address signal for the second line data to be loaded from the processor;
extracting, by the controller, the second line data corresponding to the second address signal from the storage memory in response to the second request signal;
loading, by the controller, the extracted second line data into the shared memory; and
upon completing the loading of the extracted second line data, transmitting, by the controller, a second completion signal to the processor.

10. The method of claim 8, wherein the reading further includes:
receiving, by the controller, a second request signal requesting loading of second line data and a second address signal for the second line data to be loaded from the processor while loading the update data into the shared memory;
holding, by the controller, the second request signal and the second address signal;
upon loading all the update data into the shared memory, extracting, by the controller, the second line data corresponding to the second address signal from the storage memory in response to the second request signal;
loading, by the controller, the extracted second line data into the shared memory; and
upon completing the loading of the extracted second line data, transmitting, by the controller, a second completion signal to the processor.

11. A timing controller comprising:
a storage memory that stores a plurality of pieces of region data including a plurality of pieces of line data;
a processor that requests loading of the plurality of pieces of line data included in the region data using a request signal and an address signal, receives and processes the loaded line data, and transmits the processed line data; and
a controller that includes a shared memory, in which the line data is loaded and transmitted, and loads line data extracted from the storage memory into the shared memory in response to the request signal,
wherein the controller is configured to:
transfer the line data loaded into the shared memory to the processor; and
read update data for updating an operation of the storage memory from the storage memory in response to the transfer of the line data.

12. The timing controller of claim 11, wherein the controller reads update data from the storage memory and loads the read update data into the shared memory while the processor is processing the line data.

13. The timing controller of claim 12, wherein the controller loads the read update data into a reserved area of the shared memory.

14. The timing controller of claim 13, wherein the reserved area is a different area from an area in which the line data is loaded among storage areas of the shared memory.

15. The timing controller of claim 12, wherein the controller, upon receiving the request signal and the address signal from the processor, extracts the line data corresponding to the address signal from the storage memory in response to the request signal, and loads the extracted line data into the shared memory.

16. The timing controller of claim 15, wherein the controller reads the update data from the storage memory in response to the transfer of the line data, and loads the read update data into the shared memory.

17. The timing controller of claim 16, wherein the controller, when a request for next line data is received from the processor after loading all the update data into the shared memory, extracts the next line data from the storage memory, and stores the extracted next line data in the shared memory.

18. The timing controller of claim 16, wherein the controller, when a request for next line data is received from the processor while loading the update data into the shared memory, holds the request for the next line data.

19. The timing controller of claim 18, wherein the controller holds the request for the next line data during a time taken to load all the update data into the shared memory.

20. The timing controller of claim 11, wherein the update data has the same size as a size of one sector of the storage memory.
